(19) United States
(12) Patent Application Publication
(10) Pub. No.: US 2006/0159039 A1
(43) Pub. Date: Jul. 20, 2006

(54) Method and system for providing private voice call service to mobile subscriber and wireless soft switch apparatus therefor

(76) Inventors: Tae-Sung Jung, Suwon-si (KR); Se-Hun Hwang, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/312,633

(22) Filed: Dec. 21, 2005

(30) Foreign Application Priority Data
Dec. 21, 2004 (JP) 2004-109936

(51) Int. Cl. H04B 7/185

(52) U.S. Cl. 370/316; 370/252

(57) ABSTRACT

A method and system for providing a private voice call service to a mobile subscriber are provided. A soft switch in a mobile communication system, upon receipt of an origination message including a private voice request information from a calling MS, transmits to a VPN server a private circuit service request message including a service ID for the private voice call service and the network address information of a caller and called. The VPN server establishes a communication path for edge routers connected to calling and called gateways according to network address information. Thus, voice traffic is transmitted between the calling MS and called MS though the communication path of the VPN.

### PRIORITY

This application claims the benefit under 35 U.S.C. § 119(a) of Korean Patent Application No. 2004-109936, filed Dec. 21, 2004, in the Korean Intellectual Property, the entire contents of which are hereby incorporated reference.

### BACKGROUND OF THE INVENTION

1. Field of the Invention

The present invention relates generally to a method and system for transmitting a voice call in a communication system. More particularly, the present invention relates to a method and system for providing a voice call service by Voice over Internet Protocol (VoIP) in a mobile communication system based on IP networks.

2. Description of the Related Art

Along with the development of mobile communication technology, existing mobile communication systems are able to transmit a voice call over an IP network and are transitioning toward All-IP networks by VoIP technology that transmit voice over an IP network, beyond traditional E1 connectivity. For this purpose, the standardization bodies 3rd Generation Partnership Project (3GPP), 3GPP2 and International Telecommunication Union-Telecommunication sector (ITU-T) presented the concept of separating a conventional wired switch or a Mobile Switching Center (MSC) into a soft switch and a media gateway.

The soft switch is a switching component to provide voice service over a packet-switched network rather than over a legacy circuit-switched network, Public Switched Telephone Network (PSTN). The soft switch is a software-based platform that accommodates the protocols H.323, Session Initiation Protocol (SIP), Media Gateway Control Protocol (MGCP), and Media Gateway Control (MEGACO)/H.248 in order to meet the features of existing switching equipment, such as signaling compatibility and inter-operability with the PSTN, in order to enable a voice service over the packet-switched network. The soft switch is responsible for call processing for a circuit service and commands a media gateway (MGW or WGW) to connect different media by means of MEGACO messages.

The MGW is data conversion equipment for transmitting data between heterogeneous networks working on different standards. For example, it supports a circuit-switched network connection function and a packet-switched network (that is, IP network) connection function and serves as a gateway that translates traffic between the circuit-switched network and the packet-switched network. The MGW includes an Access Gateway (AGW) and a Trunk Gateway (TGW). The AGW transmits a voice signal received from a standard telephone over a wired/wireless network to a packet-switched network and the TGW transmits a signal received from the PSTN to the packet-switched network. This conventional switching network provides convenient connectivity and use to subscribers, but is vulnerable to security attacks. In this context, Virtual Private Network (VPN) technology has recently attracted interest, which builds private networks over a public network such as the Internet. The VPN technology offers an advanced security service by compressing and encrypting packets transmitted between end points in a communication network and transmitting the packets by tunneling so that malicious users like a hacker are blocked from intercepting packets or even if they access the packets, they are blocked from interpreting them.

A dedicated Wide Area Network (WAN) which connects sites by a permanent link and a dial network which builds a private network over the PSTN when needed are examples of a VPN that provides communications between different areas. Driven by the need for connecting a private network to a faster Internet, many service providers are interested in developing a VPN based on IP operating over the Internet. The reason is that Internet services are available all over the world and at relatively low prices.

FIG. 1 illustrates a typical Internet Service Provider (ISP) VPN. Referring to FIG. 1, a VPN subscriber at a particular location is connected to a VPN via a Customer Promise Equipment (CPE) router 10a, 10b, 10c or 10d. ISP edge routers 20a, 20b and 20c are ISP-operated devices for routing subscriber data received from the CPE routers 10a to 10d to private network destinations. The CPE routers 10a to 10d are physically connected to the ISP edge routers 20a, 20b and 20c by so-called stub links. The ISP edge routers 20a, 20b and 20c are connected to one another by IP tunnels. When needed, the VPN illustrated in FIG. 1 can be provided with a backup link and a backdoor link.

FIG. 2 is a block diagram illustrating the configuration of a typical mobile communication system connected to a circuit-switched network. With reference to FIG. 2, a conventional Code Division Multiple Access (CDMA) circuit switch service will be described. The circuit switch service is triggered in the CDMA system upon receipt of a Connection Management (CM) Service Request message for call origination from a Mobile Station (MS) 1 at a Wireless Soft Switch (WSS) 30 in a wireless network. The MS 1 also transmits to the WSS 30 its International Mobile Subscriber Identity (IMSI), a Called Party Binary Code Decimal (BCD) Number, and a Service Type by the CM Service Request message.

The WSS 30 analyzes the CM Service Request message received from the MS 1 through a Base Station System (BSS) 2 and secures radio resources by exchanging Assignment Request/Response messages with a Base Station Controller (BSC: not shown). The WSS 30 also extracts the router information of an IP network 60 by translating the Called Party BCD number. The extracted router information is set such that the WSS 30 can exchange ISDN User Part (ISUP) messages, Session Initiation Protocol (SIP) messages or SIP for Telephone (SIP-T) messages with a called switch, such as a soft switch (SS) 72 in a PSTN 70 or a WSS 82 in a Public Land Mobile Network (PLMN) 80. A call setup procedure with the called switch by ISUP messages is illustrated in FIG. 3. Exemplary MEGACO messages exchanged between the WSS 30 and a WGW 40 are shown in the call setup procedure. After the call setup in the procedure of FIG. 3, the WSS 30 being a calling switch exchanges voice traffic with the called switch, SS 72 or WSS 82, through the WGW 40. Since the call setup procedure of FIG. 3 is well known to those skilled in the art, its detailed description is not provided herein.

A voice call service requiring security is difficult to provide over the typical circuit-switched network illustrated in FIG. 2. Because a private voice call serviced in the conventional VPN illustrated in FIG. 1 is connected via a dedicated circuit line, the private voice call is available to authorized users only and inaccessible to general communication subscribers.

Although the private voice call service can be provided using a secret key over the CDMA network of FIG. 2, a transport channel must be encrypted using the secret key as well as a CDMA code for transmission in the air between the MS 1 and the BSS 2, resulting in dissipation of radio resources.

### SUMMARY OF THE INVENTION

Accordingly, an object of the present invention is to substantially solve at least the above problems and/or disadvantages and to provide at least the advantages below. Another object of the present invention provides a method and system for easily providing a private voice call service to general mobile subscribers.

Still another object of the present invention provides a method and system for providing a private voice call service as an additional service to general mobile subscribers through interworking between a VPN and a WSS/WGW which interworks with a Core Network (CN) by IP in a mobile communication system.

And another object of the present invention provides a WSS for providing a private voice call service to general mobile subscribers through interworking with a VPN in a mobile communication system.

In accordance with one aspect of the present invention, a method for providing a private voice call service to a mobile subscriber is provided. The method comprises a soft switch in a mobile communication system, which upon receipt of an origination message including voice privacy request information from a calling MS, transmits to a VPN server a private circuit service request message including a service ID for the private voice call service and the network address information of a caller and a called. The VPN server establishes a communication path for edge routers connected to calling and called gateways according to the network address information. Thus, voice traffic is transmitted between the calling MS and a called MS though the communication path of the VPN.

According to another aspect of the present invention, in a system for providing a private voice call service to a mobile subscriber, a calling soft switch, upon receipt of an origination message including private voice request information from a calling MS, transmits to a VPN a private circuit service request message including a service ID for the private voice call service and the network address information of a caller and called, and controls a calling gateway to transmit voice traffic between the calling MS and the called MS. A VPN server establishes a communication path for edge routers connected to the calling gateway and a called gateway according to the network address information. A called soft switch, upon request of the private voice call service form the calling soft switch, transmits the network address information of the called and controls the called gateway to transmit voice traffic between the calling MS and the called MS though the communication path of the VPN.

According to a further aspect of the present invention, in a soft switch apparatus for providing a private voice call service to a mobile subscriber, an HLR interworker determines whether a subscriber transmitting an origination message has subscribed to the private voice call service through an HLR. A gateway controller receives the network address information of a calling gateway connected to a VPN and controls the operation of the calling gateway. A network interworker performs signaling with a called soft switch and receives the network address information of a called gateway. A message processor processes transmission and reception of messages related to voice call connection and release for the mobile subscriber, and transmits a private circuit service request message requesting transmission of voice traffic from the mobile subscriber over the VPN to a server of the VPN, if the origination message comprises private voice request information.

### BRIEF DESCRIPTION OF THE DRAWINGS

The above and other objects, exemplary features and advantages of the present invention will become more apparent from the following detailed description when taken in conjunction with the accompanying drawings, in which:

FIG. 1 illustrates a typical ISP VPN;

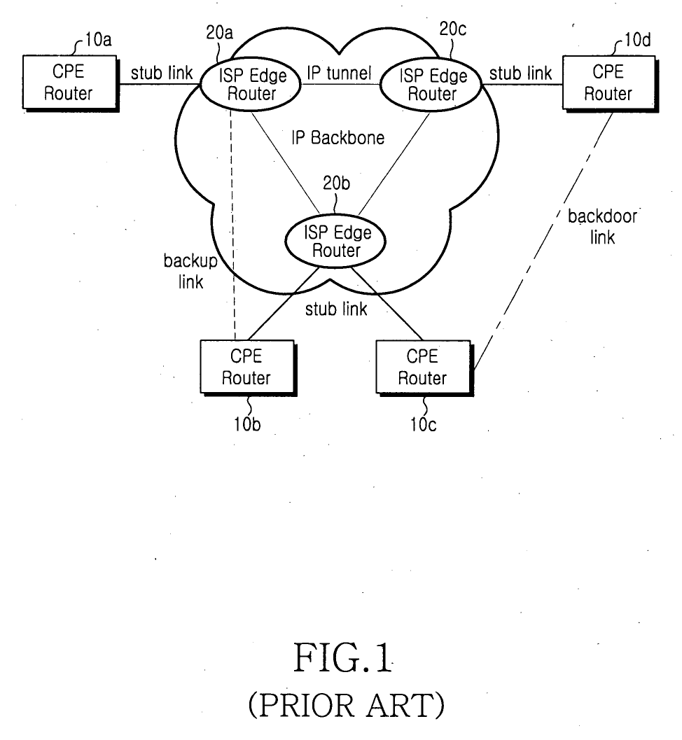

FIG. 2 is a block diagram illustrating the configuration of a typical mobile communication system connected to a circuit-switched network;

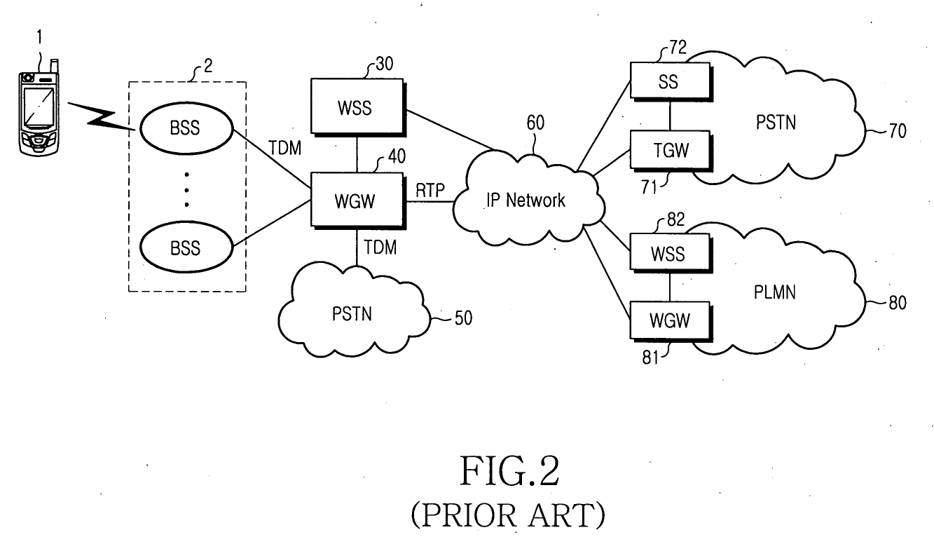

FIG. 3 is a diagram illustrating a signal flow for a call setup procedure between the typical mobile communication system and a PSTN;

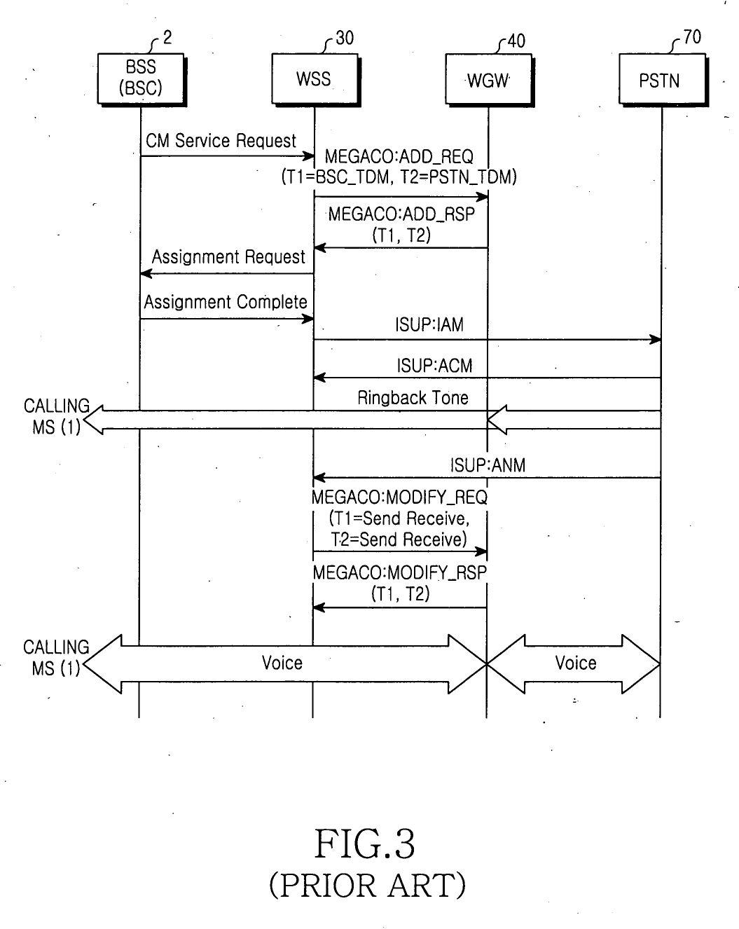

FIG. 4 is a block diagram of a circuit-switched network for providing a private voice call service to a mobile subscriber according to an exemplary embodiment of the present invention;

FIG. 5 sequentially illustrates an operation for providing the private voice call service to the mobile subscriber through interworking between a VPN and a mobile communication system in the configuration illustrated in FIG. 4, in accordance with an exemplary embodiment of the present invention;

FIG. 6 is a block diagram of a WSS according to an exemplary embodiment of the present invention;

FIG. 7 is a diagram illustrating a signal flow for an operation for providing the private voice call service to the mobile subscriber according to an exemplary embodiment of the present invention; and

FIG. 8 illustrates the format of a newly defined Private Circuit Service Request message according to an exemplary embodiment of the present invention.

Throughout the drawings, like reference numbers should be understood to refer to like elements, features, and structures.

### DETAILED DESCRIPTION OF EXEMPLARY EMBODIMENTS

The matters exemplified in this description are provided to assist in a comprehensive understanding of various exemplary embodiments of the present invention disclosed with reference to the accompanying figures. Accordingly, those of ordinary skill in the art will recognize that various changes and modifications of the exemplary embodiments described herein can be made without departing from the scope and spirit of the claimed invention. Descriptions of well-known functions and constructions are omitted for clarity and conciseness.

The following description is made with the appreciation that a mobile communication system which an MS accesses is a CDMA system by way of example and a circuit-switched network is so configured that a WSS/WGW interworking with a CN by IP in the CDMA system interworks with a VPN by Real Time Protocol (RTP), for transmission of a voice call. The present invention is not limited to a CDMA system and thus it is applicable to many systems including Time Division Multiple Access (TDMA) and Wideband CDMA (WCDMA). Since the VPN transmits a voice call through an ISP edge router, it will be referred to as a Virtual Private Router Network (VPRN) hereinafter.

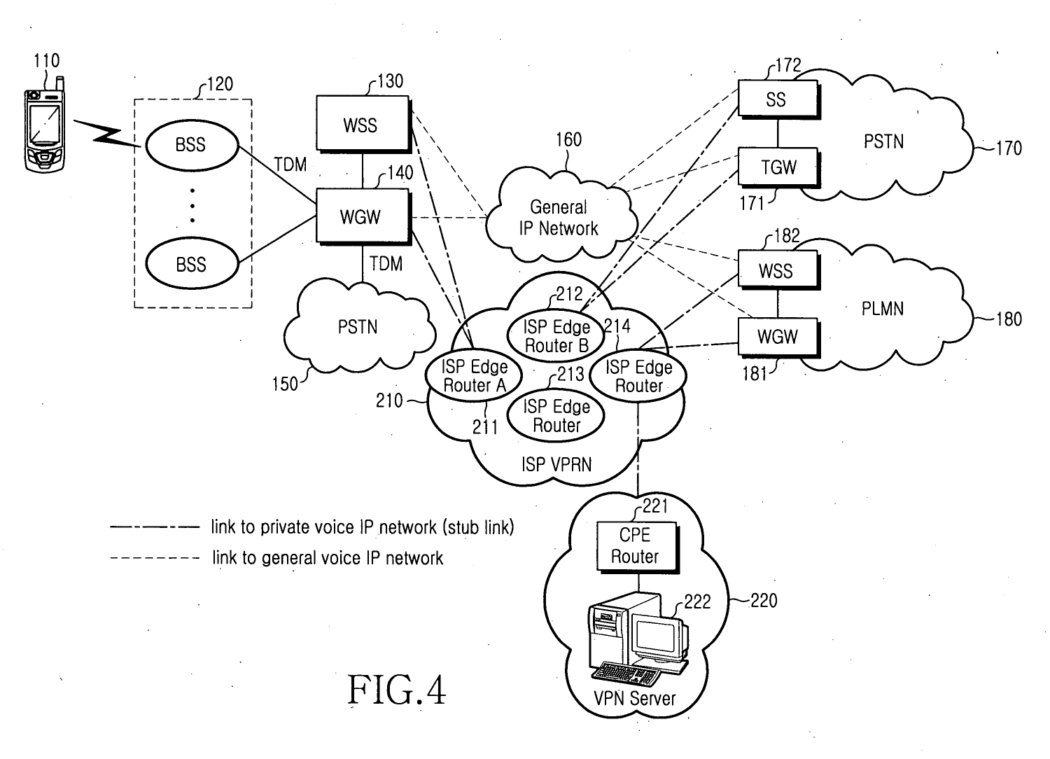

FIG. 4 is a block diagram of a circuit-switched network for providing a private voice call service to a mobile subscriber according to an exemplary embodiment of the present invention. In FIG. 4, solid lines denote links to a private voice IP network for transmitting a voice call between a CDMA network and a VPRN, and dotted lines denote links to a general voice IP network for transmitting a voice call between the CDMA network and a general IP network.

Referring to FIG. 4, an MS 110 wirelessly communicates with a plurality of BSSs 120 in a mobile communication system. The BSSs 120 interwork with a WGW 140 in time division multiplexing (TDM). The WGW 140 is connected to a PSTN 150 in TDM and responsible for translation of traffic data between the mobile communication system and a general IP network 160, or between the mobile communication system and a VPRN 210 under the control of a WSS 130. For signaling, the WSS 130 is connected to an SS 172 of a PSTN 170 or a WSS 182 of a PLMN 180 through the general IP network 160 or the ISP VPRN 210, and transmits a voice call from a caller to called in a called network.

The WGW 140 and the WSS 130, which transmit a voice call from the MS 110 to the PSTN 170 or the PLMN 180, are connected to an edge router 211 of the VPRN 210 via a stub link. A TGW 171 and the SS 172 in the PSTN 170 are connected to an edge router 212 via a stub link, and a WGW 181 and the WSS 182 in the PLMN 180 are connected to an edge router 214 via a stub link.

Thus, the TGW 171 and WGW 181 have virtual routing domain functionality with the aim to interwork with the VPRN 210 separately from the general IP network 160. The VPRN 210 is provided with a plurality of edge routers 211 to 214 for connection to other networks. Each of the edge routers 211 to 214 is configured to exchange signaling messages with the networks in order to route a voice call in a path indicated by a VPN server 222.

The VPN server 222 may reside in an ISP network 220. It is connected to an edge router 214 in the VPRN 210 via a stub link through a CPE router 221. In the present invention, the VPN server 222 receives from the WSS 130 a Privacy Circuit Service Request message including the IP addresses and User Datagram Protocol (UDP) port information of the caller and the called, and sets routing paths for the edge routers 211 to 214 for transmission of voice packets.

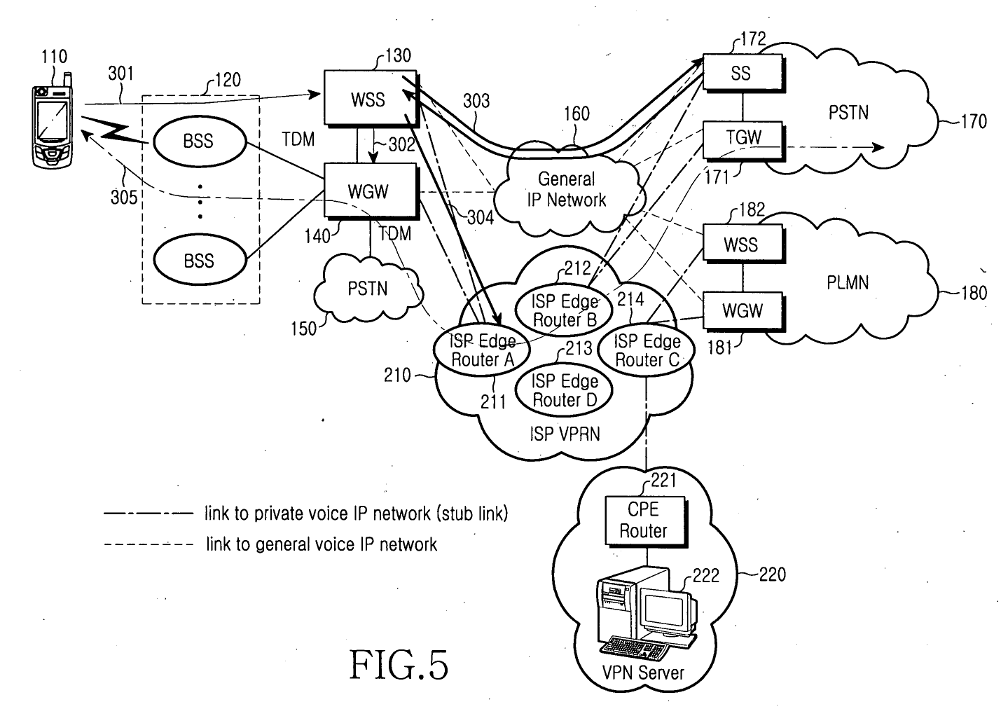

FIG. 5 sequentially illustrates an operation for providing a private voice call service to a mobile subscriber through interworking between the mobile communication system and the VPRN in the configuration illustrated in FIG. 4, in accordance with an exemplary embodiment of the present invention.

Referring to FIG. 5, the MS 110 transmits a CM Service Request message requesting a private voice call service to the WSS 130 in step 301. In one exemplary embodiment of the present invention, the CM Service Request message comprises a predetermined Voice Privacy Request field by which to request the private voice call service.

In step 302, the WSS 130 requests a Session Description Protocol (SDP) information to the WGW 140, for connection to the VPRN 210. The WGW 140 allocates a UDP port to an IP interface connected to the edge router 211 of the VPRN 210 and conveys to the WSS 130 the IP interface and the UDP port.

The WSS 130 transmits a Session Initiation Protocol (SIP) message including a Voice Privacy Request to the SS 172 of the called PSTN network 170, and the SS 172 requests SDP information from the TGW 171 for connection to the VPRN 210, in step 303. The WSS 130 receives an SIP message from the SS 172 comprising the UDP port information of an IP interface connected to the edge router 212 of the VPRN 210, created from the TGW 171 as a response for the SIP message.

In step 304, the WSS 130 transmits a signaling message comprising the IP addresses of the WGW 140 and the TGW 171 and a VPN service identifier (ID) preset between the WSS 130 and the ISP to the VPN server 222 through the edge router 211, and receives a response message from the VPN server 222 through the edge router 214. A VPN service ID can be used for authentication of the private voice call service.

Voice traffic is exchanged between the calling MS 110 and a called MS (not shown) connected to the PSTN 170 through the VPRN 210 connected between the WGW 140 and the TGW 171.

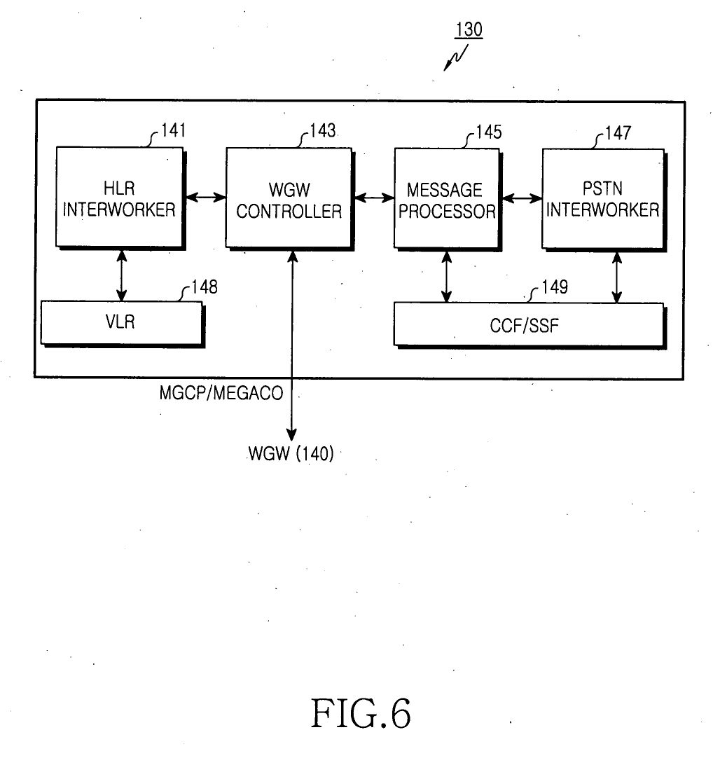

With reference to FIG. 6, a WSS 130 for performing signaling with the VPRN to provide a private voice call service will be described in great detail.

FIG. 6 is a block diagram of the WSS according to an exemplary embodiment of the present invention. In reference to FIGS. 4 and 5, upon receipt of a general CM Service Request message from a mobile subscriber, the WSS 130 transmits a voice call from the caller to a called subscriber over the general IP network 160. Upon receipt of a CM Service Request message comprising a Voice Privacy Request for a private call as an origination message, the WSS 130 acquires the RTP information of the WGW 140 and the TGW 171/WGW 181 by signaling with the SS 172 of the PSTN 170 and the WSS 182 of the PLMN 180, and transmits a predetermined Private Circuit Service Request message comprisng the RTP information and a preset VPN service ID to the VPN server 222 for transmission of voice traffic from the caller to the called through the VPRN 210.

Referring to FIG. 6, a Home Location Register (HLR) interworker 141 determines whether the subscriber requesting the private voice call service has subscribed to the private voice call service as an additional service by verifying the subscriber information of the subscriber retrieved from an HLR (not shown). A WGW controller 143, upon receipt of a voice call connection message from a message processor 145, determines whether the subscriber has requested the private voice call service, receives SDP information from the WGW 140 for establishing a session with the general IP network or the VPRN 210, and exchanges control signals with the WGW 140 for transmission of voice traffic. Furthermore, it is understood that the WGW controller 143 comprises a controller's function controlling this softswitch on the whole as well as a gateway controlling function in an exemplary embodiment of the present invention.

Message processor 145 also receives a CM Service Request message from the subscriber. If the CM Service Request message requests the private voice call service, the message processor 145 transmits a Private Circuit Service Request message to the VPN server 222 of the VPRN 210 under the control of the WGW controller 143. It transmits/receives messages required for providing the private voice call service and other additional services to the subscriber according to an exemplary embodiment of the present invention. A PSTN interworker 147 receives SDP information from the SS 172 of the PSTN 170 through the message processor 145 and controls call connection service to the PSTN. A Visitor Location Register (VLR) 148 stores the location registration information of the subscriber. A Call Control Function (CCF)/Service Switching Function (SSF) 149 processes the call status and additional services of the subscriber. The PSTN interworker 147 is provided to connect a private voice call between the mobile communication network and the PSTN in an exemplary embodiment of the present invention. According to the type of connected network, an appropriate interworking device is configured for the network.

The method of providing the private voice call service in the mobile communication system will be described in more detail.

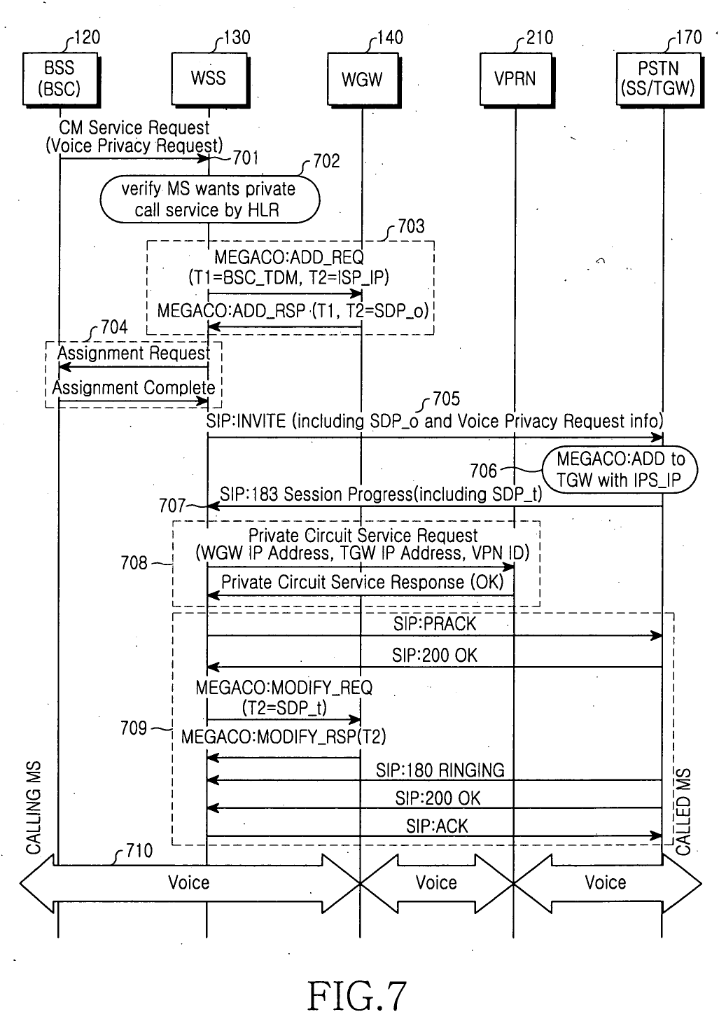

FIG. 7 is a diagram illustrating signal flow for an operation providing private voice call service to a mobile subscriber according to an exemplary embodiment of the present invention. In the private voice call procedure, a voice call originating from a mobile subscriber is transmitted to a called network over a VPRN, as illustrated in FIG. 4. The called network is assumed to be the PSTN 170 therein.

Referring to FIG. 7, the BSS 120 receives a CM Service Request message comprising a Voice Privacy Request from the calling MS 110 and provides the CM Service Request message to the WSS 130 in step 701. In step 702, the WSS 130 retrieves the subscriber information of the calling MS 110 requesting the private voice call service from the HLR (not shown) of the mobile communication system and verifies based on the subscriber information whether the MS 110 has subscribed to the private voice call service as an additional service.

In step 703, if the MS 110 is verified, the WSS 130 transmits a MEGACO message, ADD_REQ to the WGW 140, requesting resources for TDM of the BSC 120 and an IP interface connected to the ISP edge router 211. An agreement must be made for the private voice call service in advance between the WSS 130 and the ISP of the VPRN 120. For this purpose, the WSS 130 preserves information about the configuration of a particular IP interface connected to an ISP edge router among the interfaces of the WGW 140. The WGW 140 allocates a UDP port to the requested IP interface and transmits a MEGACO message, ADD_RSP including associated SDP information to the WSS 130.

The WSS 130 secures radio resources by exchanging Assignment Request/Response messages with the BSC 120 in step 704. In step 705, the WSS 130 translates the number of the called MS and transmits an SIP INVITE message to the SS 172 of the called PSTN network 170. The SIP INVITE message comprises a Voice Privacy Request along with RTP information determined by the WGW 140. The SIP INVITE message can be configured by adding information indicating the private voice call service, a=“private” to the SDP specification used in SIP.

In step 706, if receiving a=“private” in the SIP INVITE message received from the WSS 130, the SS 172 determines that the calling MS 110 has requested a private voice call and requests resources for the TDM of the PSTN 170 and an IP interface connected to the ISP edge router 212 to the TGW 171. For a private voice call service to occur, an agreement must be made between the SS 172 and the ISP of the VPRN 210. To do so, the SS 172 preserves information about the configuration of an IP interface connected to an ISP edge router among the interfaces of the TGW 171. The TGW 171 allocates a UDP port to the requested IP interface and transmits a MEGACO message ADD_RSP including associated SDP information to the SS 172.

If the a=“private” is not received in the SIP INVITE message in step 706, that is, when the private voice call service was not agreed upon between the SS 712 and the VPRN 210, the SS 172 can transmit a warning message to the WSS 130. While not shown in FIG. 7, upon receipt of the warning message, the WSS 130 deletes the IP information set for connection to the VPRN 210 from the WGW 140 and transmits an SIP INVITE message requesting RTP resources for an IP interface connected to the general IP network 160 to the SS 712, thereby setting up a non-private voice call over the general IP network 160. Preferably, the WSS 130 notifies the MS 110 that the private voice call service is unavailable through the WGW 140.

Meanwhile, upon receipt of the MEGACO message ADD_RSP in step 706, when RTP resources are completely established between the TGW 171 and the VPRN 210, the SS 172 transmits an SIP 183 Session Progress message comprising information about the RTP resources to the WSS 130 in step 707. Thus, the WSS 130 determines from the SIP 183 Session Progress message that the private voice call service is available at the called side and performs a session setup through the VPRN 210.

For the session setup, the WSS 130 transmits a Private Circuit Service Request message defined according to an exemplary embodiment of the present invention to the VPN server 222 through the edge router 211 in step 708.

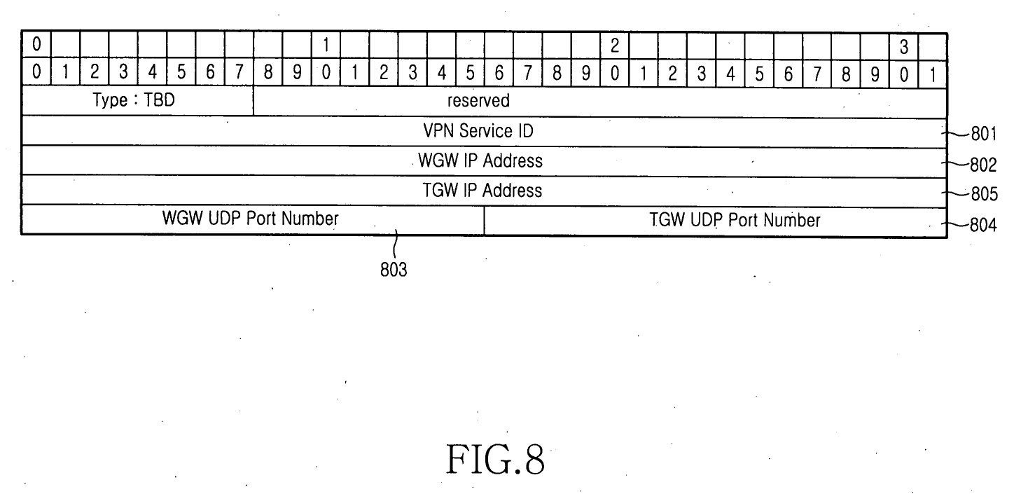

FIG. 8 illustrates the format of the Private Circuit Service Request message defined according to an exemplary embodiment of the present invention.

Referring to FIG. 8, a VPN Service ID 801 is preset for the private voice call service between the WSS 130 and the ISP VPRN 210. The Private Circuit Service Request message comprisess a WGW IP Address 802 identifying the IP interface of the WSS 130 connected to the VPRN 210 and a WGW UDP Port Number 803 determined by the WGW 140, as RTP information related to the WGW 140. The Private Circuit Service Request message further comprises a TGW IP Address 805 identifying the IP interface of the SS 172 connected to the VPRN 210 and a TGW UDP Port Number 804 determined by the TGW 171, as RTP information related to the TGW 171.

Upon receipt of the Private Circuit Service Request message having the format of FIG. 8, the VPN server 222 sets routing paths for the ISP edge routers 211 and 212 so that the ISP edge routers 211 and 212 can transmit/receive voice packets from the subscribers at the IP addresses and UDP ports requested by the WSS 130. The VPN server 222 then transmits a Private Circuit Service Response message to the WSS 130.

The voice call setup is completed by exchanging SIP messages between the WSS 130 and the SS 172 according to the standard in step 709. In step 710, voice traffic is exchanged between the BSC 120 and the PSTN 170 over the VPRN 210, while the private of the voice call is ensured in the public network. The subscriber requesting the private call is charged for the private call only when the CM Service Request message comprises the Voice Privacy Request and the charge is calculated at a charge rate agreed between the mobile communication service provider and the ISP in the present invention.

As described above, the present invention advantageously provides a private voice call service to general mobile subscribers through interworking between a WSS and a WGW/TGW which have a VoIP function and an ISP network.

While the invention has been particularly shown and described with reference to certain preferred exemplary embodiments thereof, it will be understood by those of ordinary skill in the art that various changes in form and detail may be made therein without departing from the spirit and scope of the present invention as defined by the appended claims.

What is claimed is:

1. A method of providing a private voice call service to a mobile subscriber, the method comprising:
receiving an origination message comprising private voice request information from a calling mobile station (MS) by a soft switch in a mobile communication system;
transmitting to a server of a virtual private network (VPN) a private circuit service request message comprising a service identifier (ID) for the private voice call service and the network address information of a caller and a called by the soft switch;
establishing a communication path for edge routers connected to calling and called gateways according to the network address information by the VPN server; and
transmitting voice traffic between the calling MS and a called MS though the communication path of the VPN.

2. The method of claim 1, wherein the network address information of the caller and the called comprise the Internet protocol (IP) addresses and User Datagram Protocol (UDP) port information of the calling gateway and the called gateway.

3. The method of claim 1, further comprising verifying whether the calling MS has subscribed to the private voice call service through a home location register (HLR) in the mobile communication system by the soft switch upon receipt of the origination message.

4. The method of claim 3, further comprising receiving the network address information of the called gateway through a called soft switch by the soft switch upon receipt of the origination message.

5. The method of claim 3, wherein the called MS comprises a subscriber to a public switched telephone network (PSTN).

6. The method of claim 1, further comprising:
transmitting a session initiation protocol (SIP) invite message to the called soft switch by the soft switch upon receipt of the origination message; and
receiving the private voice request information and perceiving that the calling MS has requested a private voice call by the called soft switch.

7. The method of claim 6, further comprising:
transmitting a predetermined warning message to the calling soft switch by the called soft switch if the called soft switch does not perceive the private voice request information; and
setting up the voice call over a general IP network by the calling soft switch.

8. A system for providing a private voice call service to a mobile subscriber, comprising:
a calling soft switch for, upon receipt of an origination message comprising private voice request information from a calling mobile station (MS), transmitting to a virtual private network (VPN) a private circuit service request message comprising a service identifier (ID) for the private voice call service and the network address information of a caller and a called, and controlling a calling gateway to transmit voice traffic between the calling MS and a called MS;
a server of the VPN for establishing a communication path for edge routers connected to the calling gateway and a called gateway according to the network address information; and
a called soft switch for, upon request of the private voice call service from the calling soft switch, transmitting the network address information of the called and controlling the called gateway to transmit voice traffic between the calling MS and the called MS though the communication path of the VPN.

9. The system of claim 8, wherein the network address information of the caller and the called comprise the Internet protocol (IP) addresses and User Datagram Protocol (DUP) port information of the calling gateway and the called gateway.

10. The system of claim 8, wherein the calling soft switch verifies whether the calling MS has subscribed to the private voice call service through a home location register (HLR) in the mobile communication system upon receipt of the origination message.

11. The system of claim 8, wherein if the origination message does not include the private voice request information, the calling soft switch transmits the voice call from the calling MS to the called soft switch over a general Internet protocol (IP) network.

12. The system of claim 8, wherein the calling soft switch has information about a predetermined IP interface of the calling gateway for connecting to an edge router, and the called soft switch has information about a predetermined IP interface of the called gateway for connecting to an edge router.

13. The system of claim 8, wherein upon receipt of a session initiation protocol (SIP) message comprising the private voice request information from the calling soft switch, the called soft switch determines the presence of the private voice call request from the calling MS.

14. A soft switch apparatus for providing a private voice call service to a mobile subscriber, comprising:
a home location register (HLR) interworker for determining whether a subscriber transmitting an origination message has subscribed to the private voice call service through an HLR;
a gateway controller for receiving the network address information of a calling gateway connected to a virtual private network (VPN) and controlling the operation of the calling gateway;
a network interworker for performing signaling with a called soft switch and receiving the network address information of a called gateway; and
a message processor for processing transmission and reception of messages related to voice call connection and release for the mobile subscriber, and transmitting a private circuit service request message requesting transmission of voice traffic from the mobile subscriber over the VPN to a server of the VPN, if the origination message comprises private voice request information.

15. The soft switch apparatus of claim 14, wherein the private circuit service request message comprises a service identifier (ID) for the private voice call service and the network address information of a caller and a called.

16. The soft switch apparatus of claim 15, wherein if the origination information does not include the private voice request information, the gateway controller transmits a voice call from a calling mobile station (MS) to the called soft switch over a general Internet protocol (IP) network.

17. The soft switch apparatus of claim 15, wherein the network address information of the caller and the called comprise the Internet IP addresses and User Datagram Protocol (UDP) port information of the calling gateway and the called gateway.
